(19) United States
(12) Patent Application Publication
(10) Pub. No.: US 2004/0182213 A1
(43) Pub. Date: Sep. 23, 2004

(54) Rotary die cutter for forming a non-linear line of perforations in a strip of material

(75) Inventors: Kenneth John Wagner, Greenville, WI (US); Joseph Andrew Mlinar, Appleton, WI (US)

Correspondence Address: KIMBERLY-CLARK WORLDWIDE, INC., 401 NORTH LAKE STREET, NEENAH, WI, 54956

(73) Assignee: Kimberly-Clark Worldwide, Inc.

(21) Appl. No.: 10/394,360

(22) Filed: Mar. 21, 2003

(51) Int. Cl. B26D 1/56; B23D 25/12; B26D 1/12

(52) U.S. Cl. 83/343; 83/678

(57) ABSTRACT

A rotary die cutter for forming a non-linear line of perforations in a strip of material is disclosed. The rotary die cutter includes a rotatable anvil roll and a rotatable knife roll. The knife roll has a peripheral surface with at least one knife formed thereon. The knife has a non-linear configuration. The knife extends across at least about half of the width of the knife roll and has a plurality of land areas each separated by a notch. The knife roll is coaxially aligned with the anvil roll to form a nip therebetween through which the strip of material can pass. For each rotation of the die cutter, the knife will pass through the strip of material and be brought into direct contact with the anvil roll and form a non-linear line of perforations in the strip of material.

### BACKGROUND OF THE INVENTION

Today, there exist many articles and packages that include a strip of material that have at least one tearable line of perforations formed therein. The tearable line of perforations can be torn open so as to open the article or to open the package in which the article is contained. Various packaging materials use a tear strip or a tearable line of perforations to enable the end user to easily open the package. Some disposable absorbent articles, such as infant diapers, child training pants, adult incontinence pants, feminine menstrual pants, etc. employ one or two lines of perforations to allow the wearer to open, inspect and even change the product without having to remove other articles of clothing. Many refastenable, disposable absorbent garments utilize tearable lines of perforations and refastenable attachment members which cooperate together to allow the garment to be opened and closed more than once. Such refastenable articles also permit the user to adjust the snugness of the garment relative to their body anatomy.

Up until now, most of such lines of perforations have been linear in configuration. The primary reason for forming a linear line of perforations is that it is easy to accomplish using a straight flex knife. The tooling is relatively cheap and can be quickly manufactured. However, one drawback with using a linear line of perforations is that such a design may not be the most advantageous configuration for the article or package it is to be used in or on. Many absorbent articles which are intended to be worn about the torso of a human body to absorb urine and/or feces might function better and/or appear more aesthetically pleasing if the lines of perforations were non-linear in configuration. A curved or arcuately shaped design for each line of perforations could provide the wearer of the article with extra material located adjacent to the point where the line of perforations is to be grasped so as to enable it to be easily torn open. This feature could be especially beneficial to older adults who may be suffering from arthritis. Another problem with refastenable, disposable pant-like garments is that the attachment members tend to cover up a major portion of the lines of perforations and makes them hard to be seen. This is especially true for incontinence garments being worn by elderly adults who may suffer from impaired vision. By utilizing non-linear lines of perforations, such as a concave or convex configuration, a greater portion of each of the lines of perforations is visually present. The ability of the wearer of the article to visually see and recognize the location of each tearable line of perforations is a consumer preference.

Up until now, manufacturers have shied away from having to create a non-linear line of perforations in their products and/or packages because the cost of the tooling required to make such a line of perforations is expensive and the engineering needed to make the tooling work at high speeds is difficult.

Now a rotary die cutter has been invented for forming at least one non-linear line of perforations in a strip of material in a cost effective and efficient manner.

### SUMMARY OF THE INVENTION

Briefly, this invention relates to a rotary die cutter for forming at least one non-linear line of perforations in a strip of material. The rotary die cutter includes a rotatable anvil roll having a first end, a second end, and a hardened peripheral surface located between the first and second ends. The rotary die cutter also includes a rotatable knife roll having a first end, a second end, a width extending from the first end to the second end, and a peripheral surface located between the first and second ends. The knife roll has at least one knife positioned on the peripheral surface that has a non-linear configuration. The knife extends across at least about half of the width of the knife roll and has a plurality of land areas each separated by a notch. The knife roll is coaxially aligned with the anvil roll to form a nip therebetween through which the strip of material can pass. For each rotation of the die cutter, the knife will pass through the strip of material and be brought into direct contact with the hardened peripheral surface of the anvil roll and form a non-linear line of perforations in the strip of material.

### BRIEF DESCRIPTION OF THE DRAWINGS

FIG. 1 is a perspective view of a rotary die cutter having a rotatable knife roll with at least one knife positioned thereon and a rotatable anvil roll that cooperates with the knife roll to form a non-linear line of perforations in a strip of material.

FIG. 2 is an end view of FIG. 1 showing a strip of material traveling through the nip created by the interaction of the knife roll and the anvil roll.

FIG. 3 is a top view of a strip of material depicting two non-linear lines of perforations that can be later used to form a front waist panel of a refastenable, disposable absorbent garment.

FIG. 4 is an end view of a solid knife roll having an outer peripheral surface with 5 three knives secured thereto and spaced 120 degrees apart.

FIG. 5 is an end view of a solid knife roll having an outer peripheral surface with four knives secured thereto and spaced 90 degrees apart.

FIG. 6 is an end view depicting an alternative way of securing a pair of the knives to the knife roll.

FIG. 7 is an end view depicting a pair of knives separated by a distance of less than 180 degrees.

FIG. 8 is an enlarged end view of the knife shown in FIG. 2.

FIG. 9 is an enlarged front view of three of the teeth shown in FIG. 1.

FIG. 10 is a top view of a portion of a non-linear knife having a plurality of land areas each separated by a notch wherein each land area has a pair of spaced apart side edges that are positioned on an arc A-A and are radially aligned to the direction of travel of the strip of material that is being perforated.

FIG. 11 is a top view of a portion of a non-linear knife having a plurality of land areas each separated by a notch wherein each land area has a pair of spaced apart side edges that are positioned on an arc A-A and are aligned parallel to the direction of travel of the strip of material that is being perforated.

### DETAILED DESCRIPTION

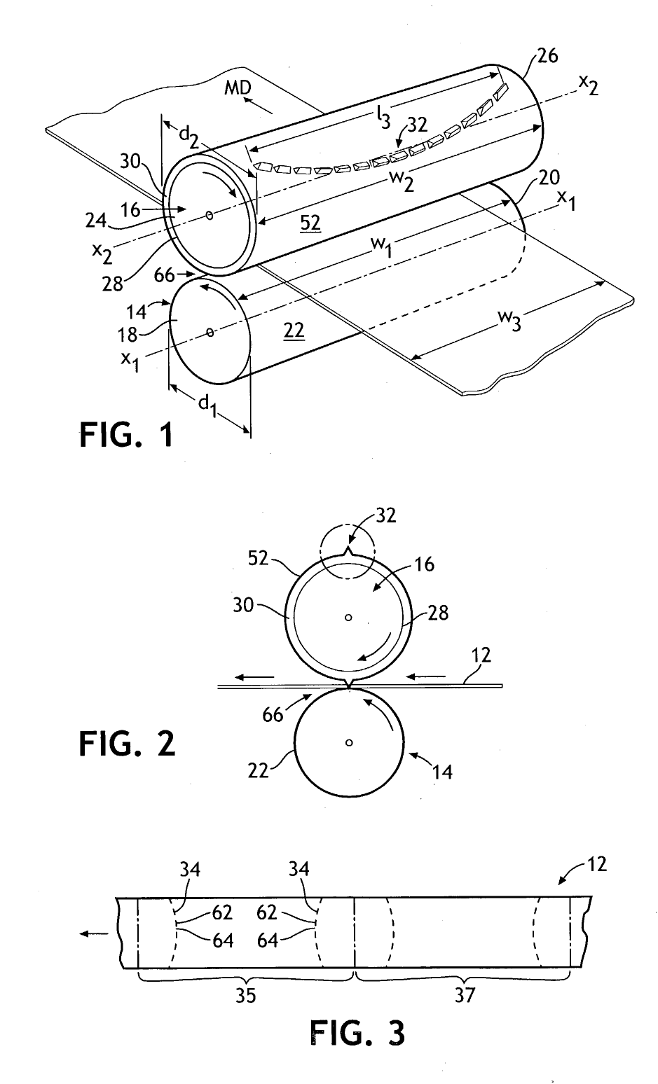

Referring to FIGS. 1 and 2, a rotary die cutter 10 is shown for forming at least one non-linear line of perforations in a strip of material 12. The rotary die cutter 10 includes a rotatable anvil roll 14 and a rotatable knife roll 16. The anvil roll 14 is cylindrical in shape and has a first end 18, a second end 20 spaced apart from said first end 18, and a longitudinal central axis X₁--X₁. The anvil roll 14 can be a solid roll that has a hardened peripheral surface 22 located between the first and second ends, 18 and 20 respectively. The anvil roll 14 can be formed from ferrous metal, steel, a steel alloy or from some other material known to those skilled in the art. Desirably, the peripheral surface 22 is smooth and free from irregularities, roughness or projections. Most desirably, the peripheral surface 22 has an even consistency of smoothness throughout. The anvil roll 14 has a diameter d₁ that can be of almost any desired dimension. The exact diameter d₁ of the anvil roll 14 should be sized to handle the length, width and thickness of the strip of material 12 that will pass over its peripheral surface 22. Desirably, the diameter d₁ of the anvil roll 14 will range from between about 2 inches (about 5 centimeters (cm)) to about 20 inches (about 51 cm). More desirably, the diameter d₁ of the anvil roll 14 will range from between about 5 inches (about 13 cm) to about 15 inches (about 38 cm). Most desirably, the diameter d₁ of the anvil roll 14 will range from between about 8 inches (about 20 cm) to about 12 inches (about 30 cm).

The anvil roll 14 also has a face width w₁ that extends from the first end 18 to the second end 20. The face width w₁ is measured parallel to the longitudinal central axis X₁--X₁. The face width w₁ can be of almost any desired dimension. Desirably, the face width w₁ will range from between about 4 inches (about 10 cm) to about 50 inches (about 127 cm). More desirably, the face width w₁ will range from between about 6 inches (about 15 cm) to about 20 inches (about 51 cm). Most desirably, the face width w₁ will range from between about 10 inches (about 25 cm) to about 14 inches (about 36 cm).

Still referring to FIGS. 1 and 2, the knife roll 16 is also cylindrical in shape and has a first end 24, a second end 26 spaced apart from the first end 24, and a longitudinal central axis X₂--X₂. The knife roll 16 can be either a solid roll or a hollow roll. Desirably, the knife rill 16 is a solid roll. The knife roll 16 has a peripheral surface 28 located between the first and second ends, 24 and 26 respectively. A collar or sleeve 30 can be positioned on, secured to or integrally formed onto the peripheral surface 28 of the knife roll 16. The collar or sleeve 30 can be snuggly fitted over the peripheral surface 28, for example by being shrink fitted in place. Other means known to those skilled in the art for securing the collar or sleeve 30 to the peripheral surface 28 can be used. The collar or sleeve 30 functions as one way of securing or attaching at least one knife 32 indirectly to the outer peripheral surface 28 of the knife roll 16. Alternatively, one or more knives 32 can be directly secured to the peripheral surface 28.

The knife roll 16 can be formed from ferrous metal, steel, a metal alloy or from some other material known to those skilled in the art. The knife roll 16 has a diameter d₂ that can be of almost any desired dimension. The diameter d₂ is the outer diameter of the knife roll 16 and would also include the thickness of any collar or sleeve 30 that may be present. The exact diameter d₂ of the knife roll 16 should be sized to handle the length, width and thickness of the strip of material 12 that will pass over its outer surface. The diameter d₂ of the knife roll 16 can be smaller than, equal to or larger than the diameter d₁ of the anvil roll 14. In order to extend the life of the knife roll 16, it is advantageous to size the diameter d₂Of the knife roll 16 to be different from the diameter d₁ of the anvil roll 14 to ensure that the knife or knives 32 do not contact the anvil roll 14 at the same location on each revolution. Desirably, diameter d₂ Of the knife roll 16 is either smaller than or larger than the diameter d₁ of the anvil roll 14. Desirably, the diameter d₂ of the knife roll 16 will range from between about 2 inches (about 5 cm) to about 20 inches (about 51 cm). More desirably, the diameter d₂ of the knife roll 16 will range from between about 5 inches (about 13 cm) to about 15 inches (about 38 cm). Most desirably, the diameter d₂ of the knife roll 16 will range from between about 8 inches (about 20 cm) to about 12 inches (about 30 cm).

The knife roll 16 also has a face width w₂ that extends from the first end 24 to the second end 26. The face width w₂ is measured parallel to the longitudinal central axis X₂-X₂. The face width w₂ can be of almost any desired dimension. Desirably, the face width W₂ will range from between about 4 inches (about 10 cm) to about 40 inches (about 102 cm). More desirably, the face width w₂ will range from between about 6 inches (about 15 cm) to about 20 inches (about 51 cm). Most desirably, the length will range from between about 10 inches (about 25 cm) to about 14 inches (about 36 cm).

Referring now to FIGS. 1-7, different ways of securing or attaching one or more knives 32 to the peripheral surface 28 of the knife roll 16 is depicted. The knife roll 16 can have a single knife 32 secured or attached to its peripheral surface 28 which protrudes radially outward from knife roll 16. However, many times, it is more desirable to secure two or more knives 32 to the peripheral surface 28. The numbers of knives 32 used will depend on how many lines of perforations 34, see FIG. 3, one wishes to form in the strip of material 12. The spacing of the lines of perforations 34 in a given length of the strip of material 12 will also impact on the number of knives 32 that are secured to the knife roll 16. In FIG. 3, the strip of material 12 has two sections 35 and 37, each of which will be used to form the front panel on a disposable absorbent garment. In each section, 35 and 37, a pair of non-linear lines of perforations 34 is formed by the die cutter 10. The shape of the lines of perforations 34 and their location on each section of material will be determined by one's particular needs.

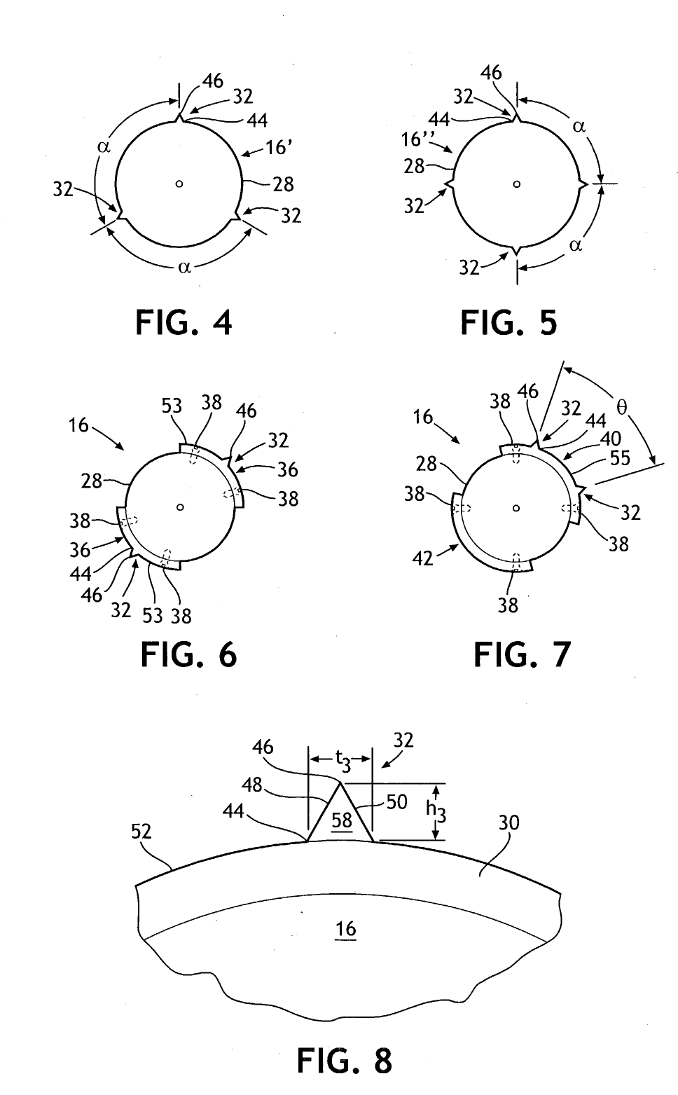

Still referring to FIGS. 1-7, the knife roll 16 will desirably have two or more knives 32 formed into or positioned on the peripheral surface 28, see FIGS. 1, 2 and 4-7. By “formed into” is meant that the knife or knives 32 can be integrally formed on or in the peripheral surface 28, such as by casting, welding or by some other means known to those skilled in the art. In FIGS. 4 and 5, the knives 32 are shown as an integral part of the knife rolls, 16′ and 16″ respectively. The knives 32 can be uniformly or randomly spaced about the peripheral surface 28 of the knife rolls 16, 16′ or 16″. In FIG. 4, three knives 32 are formed into the peripheral surface 28 and each knife 32 is uniformly spaced apart by an angle α. The angle α is 120 degrees. In FIG. 5, four knives 32 are formed into the peripheral surface 28 and each knife 32 is uniformly spaced apart by an angle α. The angle α is 90 degrees in FIG. 5.

By “positioned on” is meant that the knife or knives 32 can be physically secured to the peripheral surface 28 via an intermediate attachment member. The intermediate attachment can be by way of the collar or sleeve 30 or by a flange, bracket or some other uniquely shaped member.

In FIGS. 1 and 2, one way of attaching one or more knives 32 indirectly to the knife roll 16 is depicted. In FIGS. 1 and 2, two knives 32 are secured or attached to the collar or sleeve 30 which is then tightly fitted or permanently attached to the peripheral surface 28 of the knife roll 16. The collar or sleeve 30 can have a cylindrical shape with a relatively thin thickness. The collar or sleeve 30 can be formed from the same material as the knife roll 16 or be formed from a different material. The collar or sleeve 30 can be hardened, if desired. The two knives 32 formed on the collar or sleeve 30 are uniformly spaced 180 degrees apart.

In FIG. 6, an alternative way of attaching one or more knives 32 indirectly to the peripheral surface 28 of the knife roll 16 is depicted. Instead of a 360 degree collar 30, a pair of flanges 36 is utilized. It should be noted that a single flange 36 could be used, if desired. In FIG. 6, each flange 36 is an arcuate member that spans a predetermined angle on the peripheral surface 28 of the knife roll 16. Each flange 36 can range from between about 1 inch (about 2.54 cm) to a dimension that spans roughly about half the circumference of the peripheral surface 28. Each flange 36 contains a knife 32 and each flange 36 is secured to the peripheral surface 28 of the knife roll 16 by two or more screws 38. Desirably, four or more screws 38 are used to secure each of the flanges 36 to the outer periphery 28. Other attachment mechanisms can also be employed, such as bolts and nuts, roll pins, a slot and key mechanism, a weld joint, etc. The attachment can be a mechanical, electromechanical or chemical bond, i.e. an adhesive bond. Such means for attaching two members together are known to those skilled in the art. It should be noted that each flange 36 can be sized and shaped to fit one's particular needs. Each flange 36 can be in the form of an arcuate member, as shown in FIG. 6, or be in the shape of a rib, an L-shaped bracket, a T-shaped bracket, a portion of a rim or some other unique configuration.

It should be noted that it may be beneficial to use a pair of flanges 36 which are offset from one another so as to provide a counter balance. It has been found that a balanced knife roll 16 performs better over an extended period of time since less vibration and instability is present in the die cutter 10.

Referring to FIG. 7, another way of attaching one or more knives 32 indirectly to the peripheral surface 28 of the knife roll 16 is shown. In FIG. 7, one will notice that a flange 40 is secured to the peripheral surface 28 by two or more screws 36. The flange 40 contains two knives 32 which protrude radially outward from the flange 40 and are spaced apart by an angle ⊖. The angle ⊖ is less than about 180 degrees, desirably less than about 120 degrees, and more desirably, less than about 90 degrees. To offset or compensate for the weight of the flange 40, a counter weight flange 42 is secured to the opposite side of the peripheral surface 28 of the knife roll 16. The counter weight flange 42 does not have any knives 32 secured to it. Because no knives 32 are present, the counter weight flange 42 can be made thicker, longer or from a heavier material in order to more evenly balance the knife roll 16.

It should be noted that the flanges 36, shown in FIG. 6, and the flanges 40 and 42, shown in FIG. 7, can be shaped and sized to contact or abut against one another, if desired. When a pair of flanges are utilized on the knife roll 16, each flange can be of a different arcuate dimension yet together they can encompass 360 degrees around the circumference of the knife roll 16. When the pair of flanges 36 or the two flanges 40 and 42 do contact or abut against one another, a structure similar to the collar or sleeve 30 can be obtained.

Returning to FIGS. 1 and 2, each knife 32 rises above the outer or topmost boundary of the peripheral surface 28 and protrudes radially outward from the center point of the knife roll 16. Each knife 32 also has a non-linear configuration. “Non-linear” is defined herein as meaning not a straight line. A line that deviates from a straight line, such as a curved or arcuate line, a concave line, a convex line, two or more straight lines that are attached at an angle or aligned in close proximity to one another to form a non-linear shape, such as a V-shaped line, a W-shaped line, a saw tooth line, etc. are considered non-linear. Other non-linear configurations known to those skilled in the art can also be used. The non-linear configuration of the knife 32 is viewed as extending across the face width w₂ of the knife roll 16. Each knife 32 has a length I₃ that extends across at least about half of the face width w₂ of the knife roll 16. Desirably, each knife 32 has a length I₃ that extends across at least about 70% of the face width w₂ of the knife roll 16. More desirably, each knife 32 has a length 13 that extends across at least about 90% of the face width w₂ of the knife roll 16. Most desirably, each knife 32 has a length I₃ that extends completely across the face width w₂ of the knife roll 16.

Referring to FIG. 8, each knife 32 has a base 44, an apex 46, and a pair of side walls 48 and 50. Each knife 32 also has a height h₃ and a thickness t₃. The height h₃ is the dimension from the base 44 to the apex 46. The collar or sleeve 30 has an outer peripheral surface 52 and the base 44 is located on this surface. In FIG. 6, each of the pair of flange 36 has an outer peripheral surface 53 and the base 44 is located on this surface. In FIG. 7, the flange 40 has an outer peripheral surface 55 and the base 44 is located on this surface. The height h₃ can range from between about 0.3 cm to about 2.5 cm. Desirably, the height h₃ can range from between about 0.5 cm to about 2.1 cm. More desirably, the height h₃ can range from between about 0.7 cm to about 1.8 cm. Most desirably, the height h₃ can range from between about 0.9 cm to about 1.5 cm. The thickness t₃ of the knife 32 is the dimension between the pair of side walls 48 and 50. As shown in FIG. 8, the knife 32 has a triangular shape since the side walls 48 and 50 taper to a point or rounded edge at the apex 46. Therefore, the maximum thickness t₃ occurs approximately at the base 44. The thickness t₃ can range from between about 0.2 cm to about 1 cm at the base 44 and will taper to a cutting edge approximate the apex 46. It should be noted that other geometrical shapes for the knife 32 can be utilized if desired. The various shapes of a knife or cutting blade 32 are known to those skilled in the art.

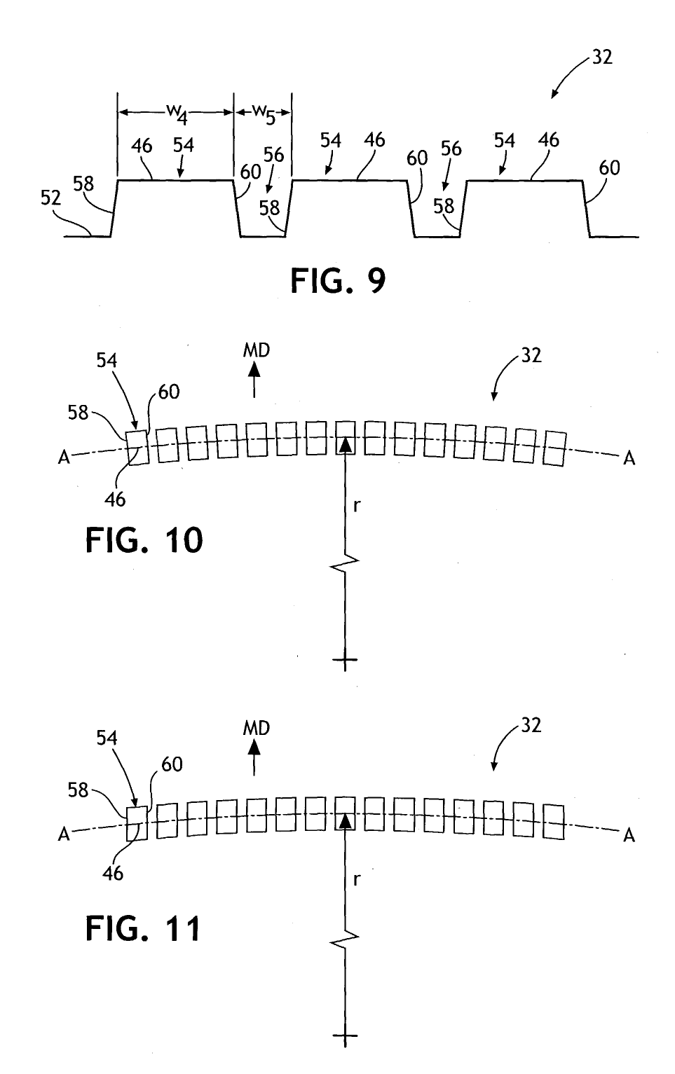

Referring now to FIG. 9, the knife 32 also has two or more land areas 54, preferably a plurality of land areas 54, each separated by a notch 56. The land areas 54 and the notches 56 cooperate to provide the knife 32 with a serrated or tooth like appearance which is capable of forming one or more lines of perforations 34 in the strip of material 12, see FIG. 3. Each land area 54 has a pair of spaced apart side edges 58 and 60. The side edges 58 and 60 can be tapered or angled relative to one another or they can be aligned parallel to one another. Normally, the side edges 58 and 60 taper inward from the peripheral surface 52 to the apex 46. However, the side edges 58 and 60 could taper outward from the peripheral surface 52 to the apex 46, if desired. The distance or dimension between the side edges 58 and 60 creates a width w₄ in each of the land areas 54 measured at the apex 46. Each of the notches 56 also has a width w₅ which is the dimension between adjacent land areas 54 measured at the plane of the apex 46. The width w₄ of each of the land areas 54 can be less than, equal to or greater than the width w₅ of each of the notches 56. The land areas 54 will correspond to the length of slits or cuts 62 formed in the strip of material 12 and the notches 56 will correspond to the unbroken areas 64 located between the slits or cuts, see FIG. 3. The land areas 54 and the notches 56 can be sized to any desired dimension so as to produce the predetermined spacing in the line of perforations 34 one wishes to obtain in the strip of material 12. It has been found that the kind of material the line of perforations 34 is formed into, the thickness of the material 12, the shape of the knife 32, the sharpness of the knife 32, the speed of the anvil roll 14 and the speed of the knife roll 16, as well as other characteristics of the die cutter 10, can all effect the appearance and shape of the line of perforations 34.

When forming one or more lines of perforations 34 in a woven or nonwoven material, such as an elastic, an elastic laminate, a thermoplastic film, a spunbond web, a bonded carded web, a stretch bonded laminate, etc., wherein the material has a thickness of less than about 1 cm, good results can be obtained when the land areas 54 are sized to have a width w₄ that is greater than the width w₅ of the adjacent notch 56 when measured at the plane of the apex 46. Desirably, the width w₄ of the land areas 54 is at least two times as large as the width w₅ of an adjacent notch 56 when measured at the plane of the apex 46. More desirably, the width w₄ of the land areas 54 is at least three times as large as the width w₅ of an adjacent notch 56 when measured at the plane of the apex 46. Most desirably, the width w₄ of the land areas 54 is at least four times as large as the width w₅ of an adjacent notch 56 when measured at the plane of the apex 46. An example of a specific width w₄ for each of the land areas 54 is 0.6 cm and a width w₅ for each of the notches 56 is 0.15 cm.

Referring again to FIG. 1, the die cutter 10 is assembled so that the anvil roll 14 and knife roll 16 are coaxially aligned and are spaced apart to form a nip 66 therebetween. The size of the nip 66 can be adjusted to accommodate the thickness of the strip of material 12 that will pass therethrough. The nip 66 can be any desired dimension but should not be larger than the height h₃ of the knife 32. The strip of material 12 should not be compressed when passing through the nip 66 unless one desires compaction to take place. The strip of material 12 will move or travel in a machine direction, designated (MD), through the die cutter 10. Desirably, the anvil roll 14 and the knife roll 16 are aligned perpendicular to the machine direction so as to enable the knife 32 to cut across the width w₃ of the strip of material 12. It should be noted that the strip of material 12 has a width w₃ and the length 13 of each knife 32 should be greater than this width w₃ Desirably, the length 13 of each knife 32 is at least about 1.5 cm greater than the width w₃ of the strip of material 12. More desirably, the length 13 of each knife 32 is at least about 2.5 cm greater than the width w₃ of the strip of material 12. This relationship is important because it will assure that as the strip of material 12 passes through the nip 66 and the line of perforations 34 can be formed regardless of any transverse movement or weave that the material 12 may experience.

The knife roll 16 can rotate in a clockwise direction while the anvil roll 14 rotates in a counter clockwise direction. As depicted in FIG. 1, this will cause the strip of material 12 to move from right to left through the die cutter 10. It is possible to reverse the rotational directions of both the anvil roll 14 and the knife roll 16, if desired. For each rotation of the die cutter 10, the knife 32 will pass through the strip of material 12 and be brought into direct contact with the hardened peripheral surface 22 of the anvil roll 14. This action will cause the serrated knife 32 to form a non-linear line of perforations 34 in the strip of material 12. The number of lines of perforations 34 and the distance the lines of perforations 34 are spaced apart from one another will depend on the number of knives 32 present on the knife roll 16, the speed of the anvil and knife rolls, 14 and 16 respectively, and the speed at which the strip of material 12 is traveling through the nip 66.

It should be noted that the surface speed of the strip of material 12 can be matched to the surface speed of the rotary die cutter 10 within plus or minus 10%. The anvil roll 14 and the knife roll 16 should be capable of operating at a surface speed of at least about 100 feet per minute, desirably at least about 1,000 feet per minute, and more desirably, at least 1,500 feet per minute. Die cutters 10 can also be constructed that are capable of even faster speeds.

The knife roll 16 can be controlled to rotate at a slower speed, the same speed or at a faster speed than the anvil roll 14. Desirably, the knife roll 16 rotates at either a faster or a slower speed than the anvil roll 14. This will help assure that for each revolution of the knife roll 16, the knife 32 does not contact the same location on the anvil roll 14. By allowing the knife 32 to contact a different location of the anvil roll 14 on subsequent revolutions, the life of the knife 32 can be extended. This decreases maintenance cost and leads to a more cost efficient operation.

Lastly, referring to FIGS. 10 and 11, two different embodiments are shown for the arrangement of the land areas 54 of the knife 32 relative to the machine direction (MD).

In FIG. 10, the land areas 54 are aligned on an arc A--A and a majority of the side edges 58 and 60 of each of the land areas 54 are aligned at an angle to the machine direction.

The arc A--A has a center point and a radius (r). In this arrangement, a majority of the 2 5 side edges 58 and 60 are radially aligned at an acute angle to the machine direction when measured from the center point of the arc A--A. The knife 32 is centered on the arc A--A such that the apex 46 of the knife 32 is coterminous with the arc A--A. It should be noted that the distance between adjacent land areas 54 can be of the same dimension, as shown, or be of a different dimension to suit one's particular needs. In FIG. 11, the land areas 54 are aligned on an arc A--A and the side edges 58 and 60 of each of the land areas 54 are aligned parallel to the machine direction. The arc A--A has a center point and a radius (r). In this arrangement, each of the side edges 58 and 60 are aligned parallel to one another and the knife 32 is centered on the arc A--A such that the apex 46 of the knife 32 is coterminous with the arc A-A. It should be noted that the distance between adjacent land areas 54 can be of the same dimension, as shown, or be of a different dimension to suit one's particular needs. The serrated knife pattern shown in FIG. 11 may be easier to manufacture than the pattern shown in FIG. 10. With the knife pattern depicted in FIG. 11, the strip of material 12 will contain a plurality of slits 62 separated by non-cut regions 64. The slits 62 will be about equal to the width w₄ of each of the land area 54 and the non-cut regions 64 will correspond in size to the distance between two adjacent land areas 54. FIG. 3 shows the slits 62 and the non-cut regions 64 after the strip of material 12 has been perforated. The slits 62 will be approximately uniform in length when formed in the strip of material 12 when using the patterns depicted in FIGS. 10 and 11.

While the invention has been described in conjunction with several specific embodiments, it is to be understood that many alternatives, modifications and variations will be apparent to those skilled in the art in light of the aforegoing description. Accordingly, this invention is intended to embrace all such alternatives, modifications and variations that fall within the spirit and scope of the appended claims.

We claim:

1. A rotary die cutter for forming a non-linear line of perforations in a strip of material, said rotary die cutter comprising:
a) a rotatable anvil roll having a first end, a second end, and a hardened peripheral surface located between said first and second ends; and
b) a rotatable knife roll having a first end, a second end, a width extending from said first end to said second end, and a peripheral surface located between said first and second ends, said knife roll having at least one knife positioned on said peripheral surface that has a non-linear configuration, said knife extending across at least about half of said width of said knife roll, said knife having a plurality of land areas each separated by a notch, and said knife roll being coaxially aligned with said anvil roll to form a nip therebetween through which said strip of material can pass, and, for each rotation of said die cutter, said knife will pass through said strip of material and be brought into direct contact with said hardened peripheral surface of said anvil roll to form a non-linear line of perforations in said strip of material.

2. The rotary die cutter of claim 1 wherein said strip of material is capable of traveling in a machine direction and said knife roll and said anvil roll are aligned perpendicular to said machine direction.

3. The rotary die cutter of claim 2 wherein said knife has a length and said strip of material has a width, and the length of said knife is greater than the width of said strip of material.

4. The rotary die cutter of claim 2 wherein each of said land areas of said knife has a pair of spaced apart side edges that are aligned parallel to said machine direction.

5. The rotary die cutter of claim 4 wherein each of said land areas has a width extending between said pair of spaced apart side edges and each notch has a width, and the width of each of said land areas is greater than the width of an adjacent notch.

6. The rotary die cutter of claim 5 wherein each of said land areas has a width that is at least three times as large as the width of an adjacent notch.

7. The rotary die cutter of claim 2 wherein each of said land areas of said knife has a pair of side edges that are aligned on an arc and a majority of said pair of side edges are radially aligned to said machine direction.

8. The rotary die cutter of claim 7 wherein said arc has a center point and a majority of said pair of side edges are aligned at an acute angle to said machine direction when measured from said center point of said arc.

9. The rotary die cutter of claim 2 wherein each of said land areas of said knife has a pair of side edges that are aligned on an arc and each of said pair of side edges are aligned parallel to said machine direction.

10. A rotary die cutter for forming at least two non-linear lines of perforations in a strip of material, said rotary die cutter comprising:
a) a rotatable anvil roll having a first end, a second end, and a hardened peripheral surface located between said first and second ends; and
b) a rotatable knife roll having a first end, a second end, a width extending from said first end to said second end, and a peripheral surface located between said first and second ends, said knife roll having at least two knives positioned on said peripheral surface, each of said knives having a non-linear configuration and each extending across at least about 75% of said width of said knife roll, each of said knives having a plurality of land areas each separated by a notch, and said knife roll being coaxially aligned with said anvil roll to form a nip therebetween through which said strip of material can pass, and, for each rotation of said die cutter, said at least two knives will pass through said strip of material and be brought into direct contact with said hardened peripheral surface of said anvil roll to form at least two non-linear lines of perforations in said strip of material.

11. The rotary die cutter of claim 10 wherein said knife roll rotates in a clockwise direction and said anvil roll rotates in a counter clockwise direction.

12. The rotary die cutter of claim 10 wherein said knife roll rotates at a faster speed than said anvil roll.

13. The rotary die cutter of claim 10 wherein said two knives are spaced less than 180 degrees apart on said peripheral surface.

14. The rotary die cutter of claim 10 wherein said knife roll has a larger diameter than said anvil roll.

15. The rotary die cutter of claim 10 wherein said strip of material is capable of traveling in a machine direction and said knife roll and said anvil roll are aligned perpendicular to said machine direction, and each of said plurality of land areas of each of said knives has a pair of spaced apart side edges that are aligned parallel to said machine direction.

16. A rotary die cutter for forming a plurality of non-linear lines of perforations in a strip of material, said rotary die cutter comprising:
a) a rotatable anvil roll having a first end, a second end, and a hardened peripheral surface located between said first and second ends; and
b) a rotatable knife roll having a first end, a second end, a width extending from said first end to said second end, and a peripheral surface located between said first and second ends, said knife roll having a plurality of knives positioned on said peripheral surface, each of said knives having a non-linear configuration and each extending completely across said width of said knife roll, each of said knives having a plurality of land areas each separated by a notch, and said knife roll being coaxially aligned with said anvil roll to form a nip therebetween through which said strip of material can pass, and, for each rotation of said die cutter, said plurality of knives will pass through said strip of material and be brought into direct contact with said hardened peripheral surface of said anvil roll to form a plurality of non-linear lines of perforations in said strip of material.

17. The rotary die cutter of claim 16 wherein said plurality of knives is randomly spaced about said peripheral surface of said knife roll.

18. The rotary die cutter of claim 16 wherein said plurality of knives is uniformly spaced about said peripheral surface of said knife roll.

19. The rotary die cutter of claim 18 wherein there are three knives spaced 120 degrees apart about said peripheral surface.

20. The rotary die cutter of claim 18 wherein there are four knives spaced 90 degrees apart about said peripheral surface.
